(19) United States
(12) Patent Application Publication
(10) Pub. No.: US 2014/0224358 A1
(43) Pub. Date: Aug. 14, 2014

(54) ACCESS PORT SEAL

(71) Applicant: Graham Brigham, Fort St. John (CA)

(72) Inventor: Graham Brigham, Fort St. John (CA)

(21) Appl. No.: 14/255,817

(22) Filed: Apr. 17, 2014

Related U.S. Application Data
(63) Continuation-in-part of application No. 13/137,568, filed on Aug. 26, 2011.

(51) Int. Cl. F16L 59/10

(52) U.S. Cl. CPC F16L 59/10
USPC 137/551

(57) ABSTRACT

An apparatus for sealing an opening in an insulated covering comprises a waterproof body locatable within the opening, the body having a periphery therearound and a groove located within the periphery, the groove being sized and shaped to closely and sealably receive an edge of the opening therein and a flexible securing means extending from the waterproof body.

### CROSS REFERENCE TO RELATED APPLICATION

This application is a continuation-in-part of application Ser. No. 13/137,568 filed Aug. 26, 2011, entitled Access Port Seal.

### BACKGROUND OF THE INVENTION

1. Field of Invention

The present invention relates to plugs in general and in particular for plugs located in insulated coverings to provide access to an interior thereof.

2. Description of Related Art

In many industries, it is frequently necessary to access pipes or other conduits to conduct inspection, maintenance and the like. One difficulty that arises with such pipes and conduits is that they are often insulated to protect the contents of the conduit from adverse weather and the like. In particular, in the oil and gas industry, it is common to provide insulation around such pipes with a sheath of protective sheet metal therearound.

Conventionally, when it has been necessary to provide access to a pipe or the contents thereof which have an insulating layer therearound, a hole has been cut in the sheet metal and the insulation removed from that region to form a cavity for access to the pipe. After the maintenance, inspection or the like has been performed on the pipe, insulation is reinserted into the cavity and a new layer of sheet metal secured over the hole to provide a patch in the original sheet metal. Problematically, such a patch has been unsatisfactory at providing the original level of insulation and protection of the pipe from adverse weather. In particular, such sheet metal patches have been known to leak when subjected to rain or melting snow.

The compromised insulation and protective sheath poses a problem for the insulation under the patch as well as the surrounding region as the insulation typically used for such applications is of a fiberglass batting or other fibrous material. Such materials are known to be intolerant of becoming wet, and being prone to compacting when damp. Such compacting of the insulation impairs the ability of the insulation to adequately insulate the pipe in that location as well as any surrounding regions which also become wet.

An additional difficulty of such patches are that once they are installed, any subsequent removal thereof for future maintenance of inspection will increase the size of the screw holes thereby further increasing the ability of water to enter the insulation.

### SUMMARY OF THE INVENTION

According to a first embodiment of the present invention there is disclosed an apparatus for sealing an opening in a metal sheath surrounding an insulated pipe, the apparatus comprising a waterproof body locatable within the opening, the body having a periphery therearound and a groove located within the periphery, the groove being sized and shaped to closely and sealably receive an edge of the opening therein and a flexible securing means extending from the waterproof body.

The body may be formed of a material selected from the group consisting of neoprene, rubber, silicone and closed cell foam. The body may be elongate with substantially parallel sides. The body may be circular.

The groove may have a constant radius. The groove may have a radius of less than ½ inch. The groove may be located in the middle of the peripheral edge. The apparatus may further comprise a leading surface of the peripheral edge extending from the groove by a distance greater than a trailing surface of the peripheral edge. At least one of the leading and trailing surfaces peripheral edge may be rounded.

The strap may be securable to the sheet metal. The strap may be integrally formed with the body. The apparatus further comprise a gasket securable to an edge of the opening in the sheet metal wherein the gasket is locatable within the groove of the body. The gasket may comprise a base ring. The strap may be securable to the base ring. The base ring may be integrally formed with the strap and the body.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an insulated pipe having a hole cut in the insulation for access to the pipe.

FIG. 2 is a perspective view of an apparatus according to a first embodiment of the present invention applied to the hole in the pipe.

FIG. 3 is a cross-sectional view of the apparatus of FIG. 2 as taken along the line 4-4 in FIG. 3.

FIG. 4 is a cross-sectional view of the apparatus of FIG. 2 located within a hole in pipe insulation as taken along the line 5-5 in FIG. 2.

FIG. 5 is a perspective view of an apparatus according to a further embodiment of the present invention applied to the hole in the pipe.

FIG. 6 is a cross-sectional view of the apparatus of FIG. 5 located within a hole in pipe insulation.

### DETAILED DESCRIPTION

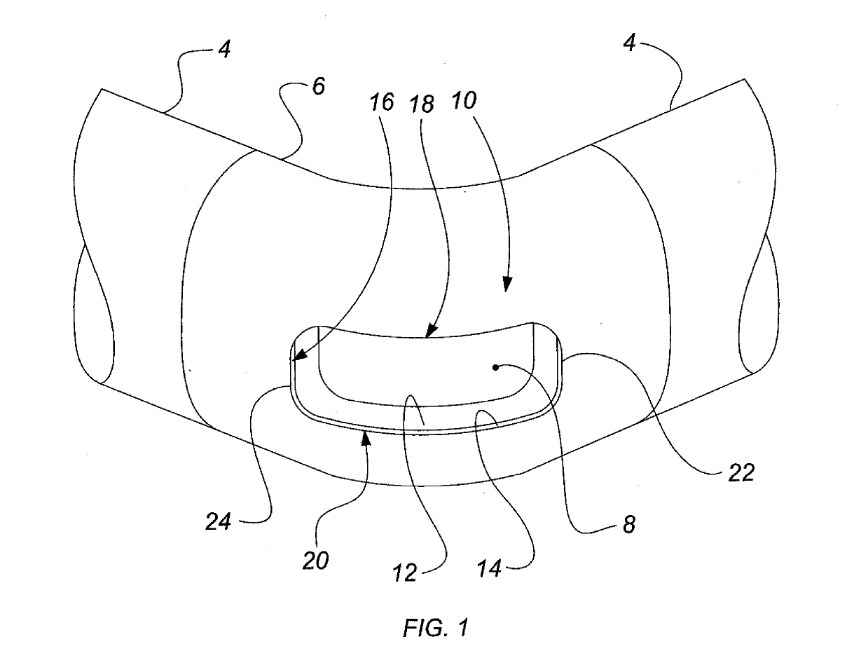

Referring to FIG. 1, an opening through pipe insulation is shown generally at 10. The pipe 8 is surrounded by an insulating layer 12 and a sheath layer 14. The opening is defined by an opening edge 16 having top and bottom straight edges, 18 and 20, respectively, and first and second arcuate portions therebetween, 22 and 24, respectively. As illustrated, the opening 10 may be located within an elbow portion 6 of the pipe and pipe insulation, however it will be appreciated that the opening may also be located within a straight portion 4 or at any other location desired by a user.

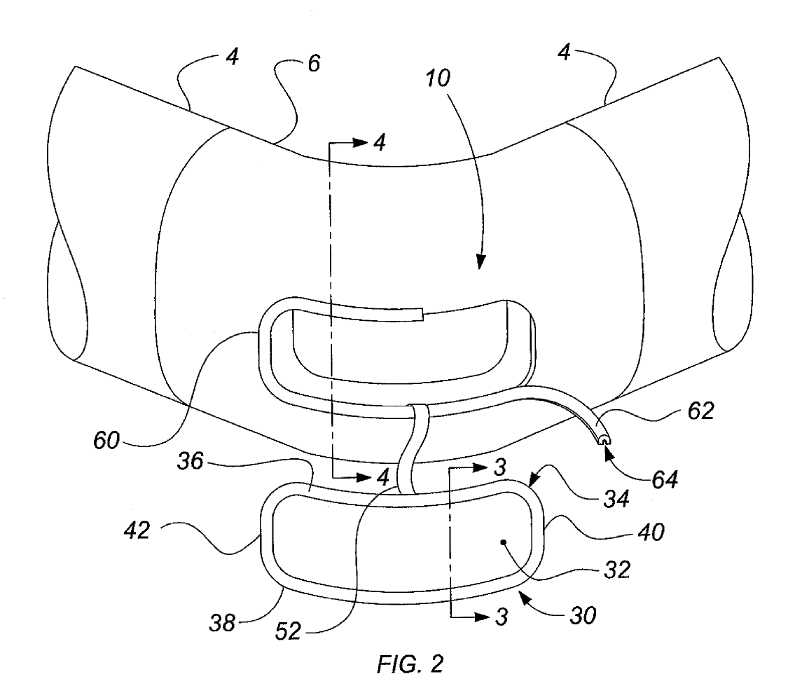

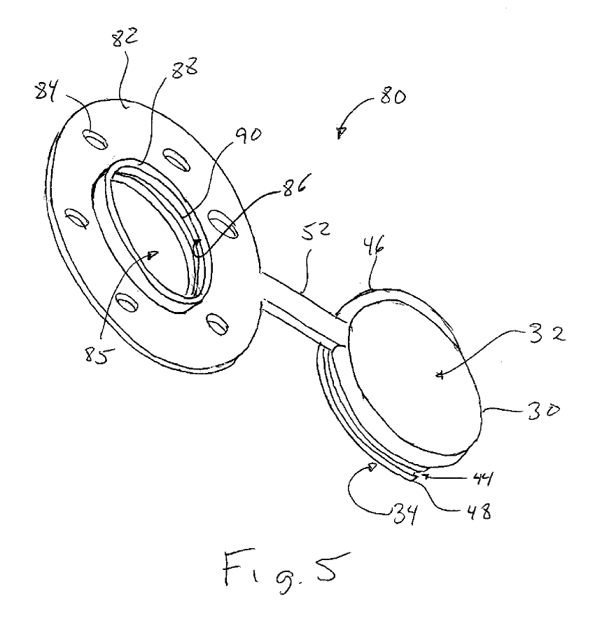

With reference to FIG. 2, the apparatus comprises a plug body 30 sized and shaped to be sealably received within the opening 10. The body comprises a member having front and rear surfaces, 32 and 34, respectively, extending between top and bottom edges 36 and 38 and first and second side arcuate ends, 40 and 42, respectively. Although the body 30 is illustrated and described as having an elongate shaped, it will be appreciated that other shapes may be utilized as well, such as, by way of non-limiting example, circular as illustrated in FIG. 5, oval, rectangular, square, triangular, octagonal or irregular. Additionally, although the body 30 is illustrated as being adapted for insertion into an elbow portion 6, it will be appreciated that the body may be adapted for fitting into a straight portion 4 or other section of the sheath member 14. For use in the straight portion 4, the body may have a straight profile whereas for an elbow portion 6, the body 30 may have a curved profile as illustrated matching or otherwise corresponding to the curvature of the intended section of the sheath layer 14. According to a further embodiment of the present invention, a gasket 60 may be provided around opening edge 16 of the opening as will be further described below.

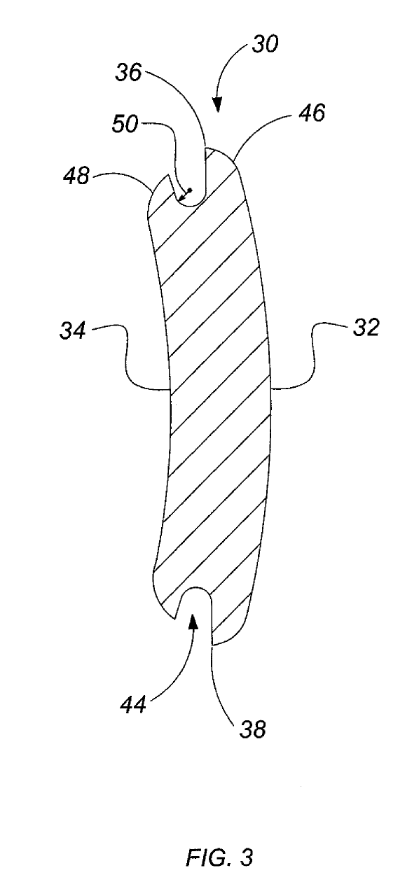

Turning now to FIG. 3, the body 30 is illustrated in cross section. The body 30 has a thickness between the front and rear surfaces 32 and 34 which may be selected to be any suitable thickness for properly sealing the opening 10. By way of non-limiting example, the body may have a thickness of between ½ and 2 inches (12 and 51 mm) with a thickness of approximately 1 inch (25 mm) having been found to be particularly useful. The top and bottom edges 36 and 38 and first and second sides 40 and 42 of the body define a periphery thereof. It will be appreciated that the top and bottom edges 36 and 38 are sized and shaped to correspond to the top and bottom edges 18 and 20 of the opening 10 and the first and second sides 40 and 42 are sized and shaped to correspond to the first and second arcuate portions 22 and 24 of the opening. In particular, it will be appreciated that a user may cut the opening 10 to correspond to the plug body 30 and in some instances may be provided with a cut template (not shown) to guide them in cutting the appropriate sized and shaped opening according to known methods.

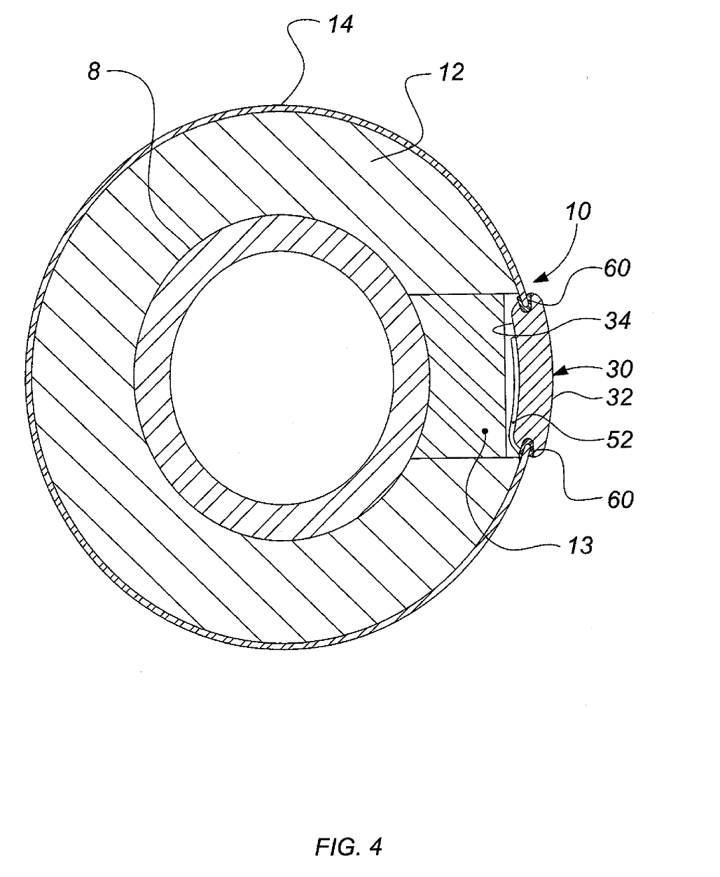

As illustrated in FIG. 3, the periphery of the body 30 is defined by the top and bottom edges 36 and 38 and first and second sides 40 and 42 and has a substantially constant profile. The body 30 also includes a groove 44 extending around the periphery and dividing the periphery into a leading and a trailing edge, 46 and 48, respectively. The leading edge 46 is disposed between the front surface 32 and the groove 44 and the trailing edge 48 is disposed between the groove and the rear surface 34 of the body 30. As illustrated, the leading and trailing edge may be rounded although it will be appreciated that other profiles may also be utilized as well, such as by way of non-limiting example, chamfered, beveled or routed. As illustrated, the groove 44 may have a semi-circular cross section having a radius generally indicated at 50 of up to ½ inch (12 mm) with a radius of ¼ inch (6 mm) having been found to be particularly useful although other profiles may be utilized as well, such as, by way of non-limiting example, v-notched, arcuate, rectangular or a slot. Optionally, a strap 52 or other suitable connector may be provided for connecting the body 30 to the sheath layer 14 wherein the strap 52 is secured between the body 30 and an inner surface of the sheath layer 14 by any known means, such as, by way of non-limiting example, screws welding adhesives or the like. As illustrated in FIG. 4, the strap 52 may be separate from the body 30 or may be integrally formed therewith as illustrated in FIG. 5.

The body 30 may be formed of any suitable waterproof material, such as by way of non-limiting example, neoprene, natural or synthetic rubber, silicone or closed cell foam. The body 30 may be formed of any known suitable method, such as by way of non-limiting example, casting, machining, utilizing a router or molding.

The gasket 60 may be of any suitable type and in one embodiment may have an outer radiused surface 62 and an inner slot. The outer radiused surface is sized to be sealably engaged within the groove 44 and may therefore have an outer radius of up to ½ inch (12 mm), such as by way of non-limiting example, Edge Trim sold as product ID WRE10B34 by Edge Lok Inc. of Buena Park Calif. The gasket may also include an inner slot 64 sized to be relieved over an edge of the sheath layer 14. The gasket may be provided as a roll which may then be cut by a user or may optionally be provided as part of a kit with a length selected to fully surround a hole as cut according to a provided template.

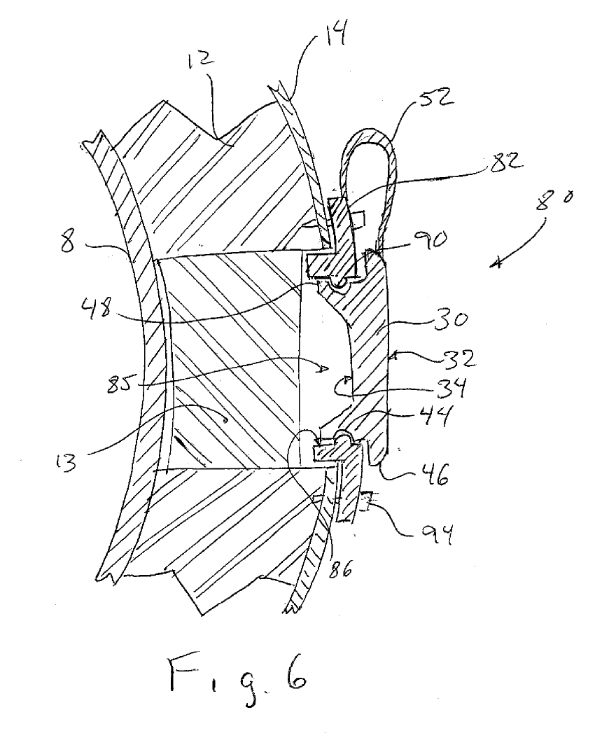

Optionally, as illustrated in FIGS. 5 and 6, the gasket may comprise a base ring 80 which is securable to the inside of the opening edge 16. The base ring 80 may be formed integrally with the body and strap 30 and 52 or may be formed separately therefrom and the components secured together with fasteners or the like. The base ring comprises a top flange 82 having a plurality of fastener bores 84 extending therethrough. An inner cylinder 88 extends away from said top flange 82 by a distance sufficient to provide an inner mounting surface 86. The top flange 82 and cylinder 88 have an inner passage 85 therethrough corresponding to the diameter or size and shape of the body 30. Although the embodiment illustrated in FIGS. 5 and 6 is illustrated as circular, any other outline as set out above may also be utilized. The inner passage 85 includes an annular ridge 90 inside of the top flange 82 sized to correspond to and be engaged within the groove 44 of the body so as to retain the body therein. As illustrated in FIG. 6, the base ring 80 may be secured within the opening edge 16 proximate to the outside of the sheet metal 14. Thereafter, fasteners 94 may be passed through the bores 84 to secure the base ring to the sheet metal layer 14.

In operation a user may cut an opening 10, optionally with the use of a provided template matched to the body 30 through the sheath layer 14 and insulating layer 12 surrounding a pipe 8. Thereafter the cut out insulation and sheath layer opening portions may be removed to provide access to the pipe for maintenance, inspection and the like. After the user has completed their activities requiring access to the pipe 8, the removed insulation or replacement insulation, generally indicated at 13 in FIG. 4 may then be replaced within the opening. The gasket 60 may then be installed over the edge of the sheath layer and the body 30 inserted such that the gasket 60 is sealably received within the groove as illustrated in FIG. 4. If future access is required to the pipe 8, the body 30 and replacement insulation 13 may be removed to provide access thereto and thereafter reinserted into the opening 10.

While specific embodiments of the invention have been described and illustrated, such embodiments should be considered illustrative of the invention only and not as limiting the invention as construed in accordance with the accompanying claims.

What is claimed is:

1. An apparatus for sealing an opening in a metal sheath surrounding an insulated pipe, the apparatus comprising
a waterproof body locatable within said opening, said body having a periphery therearound and a groove located within said periphery, said groove being sized and shaped to closely and sealably receive an edge of said opening therein; and
a flexible securing means extending from said waterproof body.

2. The apparatus of claim 1 wherein said body is formed of a material selected from the group consisting of neoprene, rubber, silicone and closed cell foam.

3. The apparatus of claim 1 wherein said body is elongate with substantially parallel sides.

4. The apparatus of claim 1 wherein said body is circular.

5. The apparatus of claim 1 wherein said groove has a constant radius.

6. The apparatus of claim 5 wherein said groove has a radius of less than ½ inch.

7. The apparatus of claim 1 wherein said groove is located in the middle of said peripheral edge.

8. The apparatus of claim 7 further comprising a leading surface of said peripheral edge extending from said groove by a distance greater than a trailing surface of said peripheral edge.

9. The apparatus of claim 8 wherein at least one of said leading and trailing surfaces peripheral edge is rounded.

10. The apparatus of claim 1 wherein said strap is securable to said sheet metal.

11. The apparatus of claim 10 wherein said strap is integrally formed with said body.

12. The apparatus of claim 1 further comprising a gasket securable to an edge of said opening in said sheet metal wherein said gasket is locatable within said groove of said body.

13. The apparatus of claim 12 wherein said gasket comprises a base ring.

14. The apparatus of claim 13 wherein said strap is securable to said base ring.

15. The apparatus of claim 14 wherein said base ring is integrally formed with said strap and said body.
